(19) United States
(12) Patent Application Publication
(10) Pub. No.: US 2017/0221091 A1
(43) Pub. Date: Aug. 3, 2017

(54) METHOD AND SYSTEM FOR PERFORMING ONLINE ADVERTISEMENT MONITORING

(71) Applicant: SIDDHANT GUPTA, UTTAR PRADESH (IN)

(72) Inventor: SIDDHANT GUPTA, UTTAR PRADESH (IN)

(21) Appl. No.: 15/328,479

(22) PCT Filed: Jul. 28, 2015
(86) PCT No.: PCT/IN2015/000298

§ 371 Date: Jan. 23, 2017

(30) Foreign Application Priority Data
Jul. 29, 2014 (IN) 2117/DEL/2014

(51) Int. Cl. G06Q 30/02

(52) U.S. Cl. CPC G06Q 30/0244; G06Q 30/0245; G06Q 30/0277; G06F 3/0488

(57) ABSTRACT

The present invention generally relates to the field of online advertising. More specifically, the present invention provides a method and system for monitoring and collecting user responses to advertisements when multiple advertisements are aggregated as slides in a single banner space rendered on user's display device. The method and system according to the present invention determines a valid impression score (VIS) by analyzing user active time on webpage, which further enables the advertisers to monitor whether the advertisements are viewed by the users or not. Also, the determined VIS enables removal/insertion/repositioning of one or multiple advertisements/slides in a banner advertisement. Generating accurate insights and results of effectiveness of advertisement for advertiser.

### FIELD OF THE INVENTION

The present invention generally relates to the field of online advertising. More specifically, the present invention relates to a method and system for monitoring and collecting user responses to multiple advertisements placed a slides in a slideshow banner are being displayed online.

### BACKGROUND OF THE INVENTION

Online advertising, also called Internet advertising, uses the Internet to deliver advertisements to consumers. Banner advertisement is a popular form of display advertising. A banner advertisement may include image, text, multimedia or any other content used for advertising purpose. To access a Web page on the Web, the user enters a URL of required web page into a browser program executing on a client system with a connection to the Internet or any other wireless network. The Web browser displays webpage and advertisements on the display device of user. However a webpage may be rendered by using multiple web servers and third party servers. As the browser displays web pages for the user, the webpage also includes advertisements.

However, the advertiser placing advertisements has little knowledge over how user is interacting with webpage /advertisement. There are instances where the advertisers are not aware of whether the advertisements provided by them on the Web pages are viewed by the users or not. Therefore, there always existed a need for a technique that monitors whether the advertisements displayed online are viewed by the users or not. When multiple advertisements being rendered in same space, this requirement is crucial. In slideshow format ,each slide is rendered for a fixed interval of time after which next slide is rendered and once each slide has rendered once the sequence will repeat itself resulting in iterations. Also there is a need to generate results, iterations wise. Further there is a need of system to operate many parameters related to multiple slides, like adding, removing, positioning of slides etc. to provide best results when multiple advertisements are rendered in slideshow format.

### OBJECTS OF THE INVENTION

An object of the present invention is to provide a method of monitoring whether the advertisements in form of slides in slideshow banner, being displayed online are viewed by the users or not.

Another object of the present invention is to provide a system for monitoring whether the monitoring whether the advertisements in form of slides in slideshow banner advertisements, being displayed online are viewed by the users or not.

Yet another object of the present invention is to provide a method of collecting user responses to advertisements being displayed online.

Still another object of the present invention is to provide a system for collecting user responses to advertisements being displayed online

Still another object of the present invention is to provide a method of modifying advertising data on users device.

Still another object of the present invention is to provide a system for modifying advertising data on user's device.

### SUMMARY OF THE INVENTION

The present invention related to a method and system for performing monitoring the effectiveness of advertisements being rendered on user's device. More specifically present invention provides a method and system for monitoring and collecting user responses to advertisements when multiple advertisements are aggregated as slides in a single banner space rendered on user's display device. Present invention determines a valid impression score of each slides by analyzing user active time on webpage during rendering time of each slide respectively. Also enabling changing or altering position, rendering time etc. of each slide, for best results of viewership of each slide. Generating a transparent system for monitoring viewership and effective rendering when multiple slides are placed in a single banner as slideshow.

### BRIEF DESCRIPTION OF THE DRAWINGS

Further aspects and advantages of the present invention will be readily understood from the following detailed description with reference to the accompanying drawings, where like reference numerals refer to identical or similar or functionally similar elements. The figures together with the detailed description below, are incorporated in and form part of the specification, and serve to further illustrate the aspects/embodiments and explain various principles and advantages, in accordance with the present invention wherein:

FIG. 1 illustrates the communication system according to an embodiment of present invention;

FIG. 2 illustrates the flowchart of the method being implemented on the client device;

FIGS. 3 and 4 illustrate events initiated by user according to embodiment of present invention;

FIG. 5 illustrates the flowchart of the method being implemented on the server device;

FIG. 6 illustrates the flowchart of the method being implemented on the server device.

Skilled artisans will appreciate that elements in the drawings are illustrated for simplicity and have not necessarily been drawn to scale. For example, the dimensions of some of the elements in the drawings may be exaggerated relative to other elements to help to improve understanding of aspects of the present invention.

### DETAILED DESCRIPTION OF THE INVENTION

Referring now to the drawings, there is shown an illustrative embodiment of performing online advertisement monitoring according to present invention. It should be understood that the invention is susceptible to various modifications and alternative forms, specific embodiments thereof have been shown by way of example in the drawings and will be described in detail below.

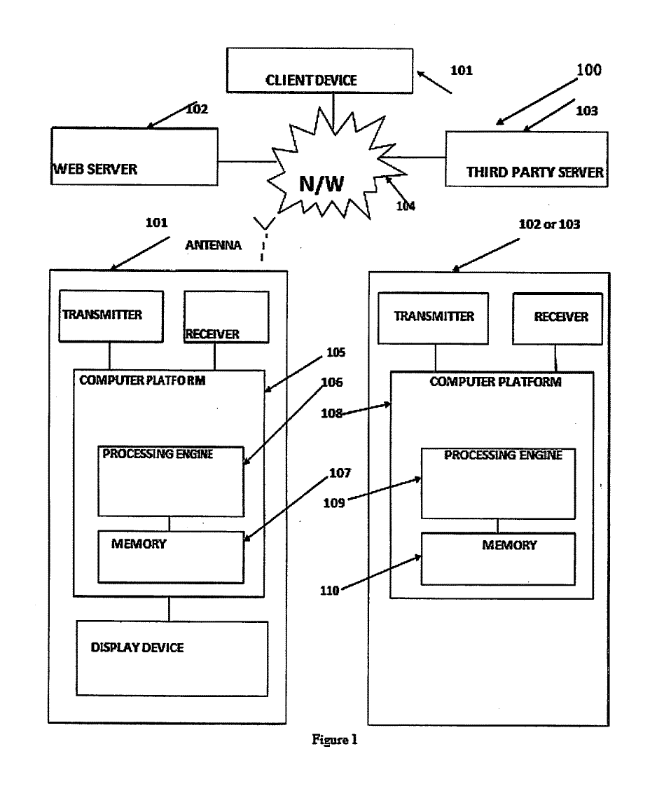

FIG. 1 illustrates communication system (100) according to an embodiment of present invention. As shown in FIG. 1, the communication system (100) comprises of at least one client device (101), at least one web server or server device (102), at least one third party server or server device (103) and a network (104). The at least one client device (101) communicates with the at least one web server (102) or the at least one third party server (103) through the network (104).

The network (104) is a communication channel which may include internet, intranet, wired network, wireless network, cloud or any other communication network.

The at least one client device (101) may be a desktop computer, laptop, mobile device, cellular telephone, tablet, user equipment or any other known device. The at least one wireless device (101) may include a transmitter, a receiver, antenna, a computer platform (105) and a display device. The computer platform (105) can transmit data across the network (104) via the transmitter to the server device (102 or 103) and can receive software applications via the receiver from the server device (102 or 103). The computer platform (105) further executes software applications and display data received from the web server (102) or the third party server (103) connected to network (104). The computer platform (105) may include a processing engine (106) and a memory (107) coupled to the processing engine (106). The processing engine (106) may include an application-specific integrated circuit (“ASIC”), or other chipset, processor, logic circuit, or other data processing device and a memory.

The memory (107) may include read-only and/or random-access memory (RAM and ROM), EPROM, EEPROM, flash cards, or any memory common to computer platforms.

Similarly, the at least one web server (server device) (102) or the third party server (103) may include a transmitter, a receiver and a computer platform (108). The computer platform (108) can transmit software applications across the network (104) via the transmitter to the client device (101) and can receive data via the receiver from the client device (101). The computer platform (108) further analyzes data received from the at least one client device (101) connected to network (104) and applies one or more rules based on the analysis of the data.

The computer platform (108) may include a processing engine (109) and a memory (110) coupled to the processing engine (109). The processing engine (109) may include an application-specific integrated circuit (“ASIC”), or other chipset, processor, controller, logic circuit, or other data processing device and a memory. The memory (110) may include read-only and/or random-access memory (RAM and ROM), EPROM, EEPROM, flash cards, or any memory common to computer platforms.

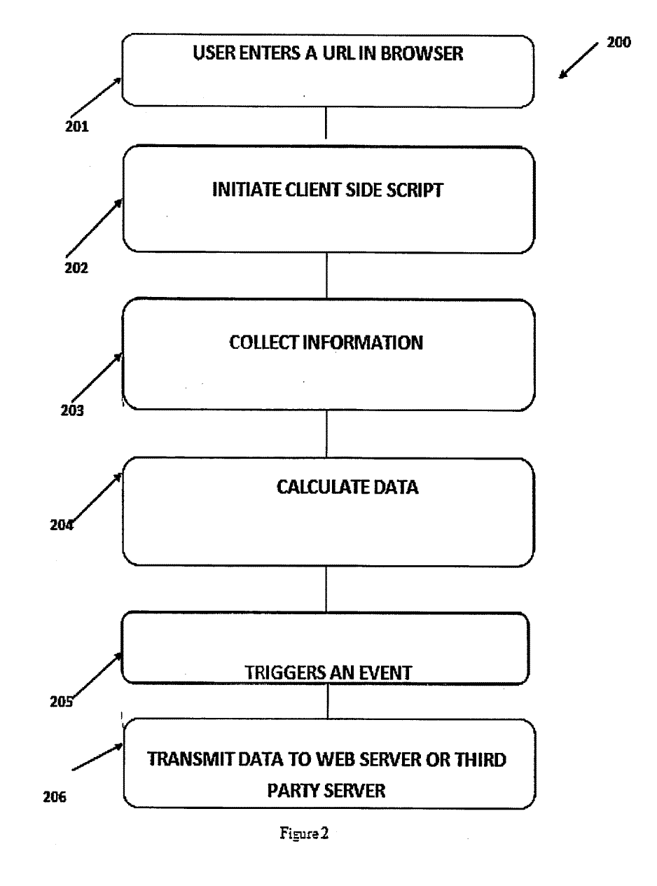

FIG. 2 illustrates the method (200) being implemented on the client device according to an embodiment of the present invention.

A user of the client device (101) uses a web browser application on the client device (101) for retrieving, presenting and traversing information. The web browser application may be but not limited to Google chrome, Mozilla Firefox, Mobile Safari etc.

In step (201) the user enters a Uniform Resource locator (URL)/ IP address in a special entry field of the browser application and sends a request to the corresponding web server or a third party server for displaying a webpage. In response, the requested webpage is rendered on the display device of the client device (101).

The webpage may include advertising content such as banner ads, pop ups or any other form used for advertising. A banner advertisement may include but not limited to image, text, video, multimedia , associated URL or any other content used for advertising purpose. A banner advertisement may contain one or multiple advertisements (slides) by using javascript, jscript or any other similar language. In case of multiple slides, each slide will be rendered on user's display device for a predetermined interval of time, once time of rendering for a slide is completed next slide will rendered on user's display device and so on. A banner advertisement may be stationary or moving with respect to scroll bar movement on the webpage. In case of multiple advertisements/slides, advertisements/slides may change infinitely or may limit to a particular number after which they start reoccurring. Also, advertisements/slides may be removed, inserted or repositioned if required. There may be variable number of advertisements/slides placed in a banner ad, which may be altered if required. Further, for convenient navigation between slides, banner ad may have next/previous buttons and bullets/objects representing each particular slide.

In step (202), a script is initiated on clients device by web server. The script may be constructed using Javascript, AJAX, VBscript, PHP, flash ,using applets or any other similar language. This script tags page and initiates the process of gathering/calculating/sending data as requested.

In step (203) the processing engine (106) of the computer platform (105) executes the script and stores/calculates information which may include but not limited to browser name and version, operating system name and version, browser zoom percent, browser window size etc. This information may be used in various ways which may include but not limited to detecting the type of client device (101). For instance, the information collected in step (203) may be used to differentiate between touch devices and mouse/trackpad devices. Further determine which parameters needs to be stored/calculated for a particular type of client device (101).

In step (204) data relating to user initiated events is calculated by the processing engine (106) as per script. Data calculated by this script can be send to one or multiple predefined web servers every time script is initiates an event. Data calculated by script can be directly send to one or multiple web servers. The script may also perform some mathematical operations on data, and then sending the results to one or multiple web servers.Also data relating to user initiated events may be stored in various ways which may include but not limited to session storage, cookies, local storage, web storage, IndexedDB, cloud storage etc.

The processing engine (106), calculates data of time associated with user initiated events which may include but not limited to touch event, scroll event, scroll bar location, keyboard event, rotation (change in calibration), mouse movement, pinch event, clicks, playing of a video/audio/game/presentation, refresh, active chat window, initiation of any hardware application (i.e. web camera), stylus movement, selection or successful/unsuccessful completion of any event or similar user initiated actions, use of next/previous button of slideshow Ad etc. Script may also create and store logs of user's interest, browsing history, search within webpage etc. Further Cookies and logs can generate Real Time results of user's interest which can be used for providing more appropriate advertisements to user. Script may send data to one or multiple web servers.

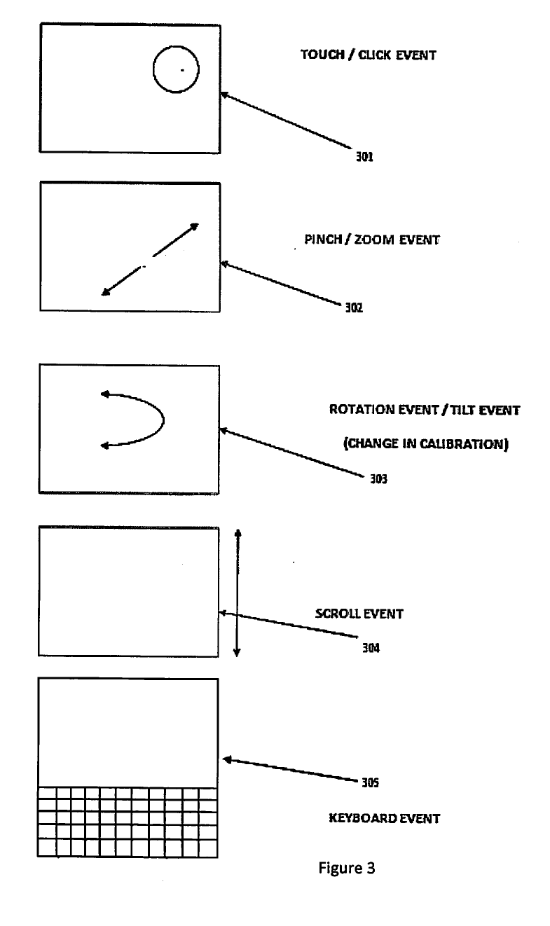

In one example, FIG. 3. illustrates the events initiated by a user on a touch based device. The events may include but not limited to touch/click event (301), pinch/zoom event (302), rotation event (change in calibration of device) (303), scroll event up/down (304), keyboard event (305), etc.

In another example, events initiated by a user on computer or laptop or any other trackpad/mouse based device may include but not limited to mouse movement/location/coordinates, click, scrollbar location/movement, keyboard event, playing a video/audio/game/presentation, usage of camera application, selection or successful completion of any field (chat window etc.) or other similar user initiated events.

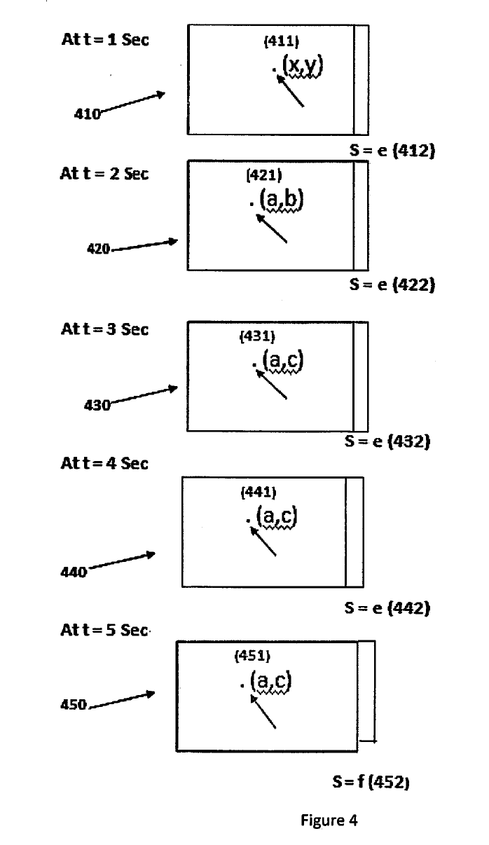

FIG. 4 illustrates an example of the events initiated by a user on a laptop based device.

As shown in FIG. 4:

410 represent the display device of the client device at t=1 sec;

411 represent the location of the mouse pointer;(i.e. x,y)

412 represent the location of the scroll bar. (i.e. e)

420 represent the display device of the client device at t=2 sec;

421 represent the location of the mouse pointer; (i.e. a,b)

422 represent the location of the scroll bar. (i.e. e)

430 represent the display device of the client device at t=3 sec;

431 represent the location of the mouse pointer; (i.e. a,c)

432 represent the location of the scroll bar. (i.e. e)

440 represent the display device of the client device at t=4 sec;

441 represent the location of the mouse pointer; (i.e. a,c)

442 represent the location of the scroll bar. (i.e. e)

450 represent the display device of the client device at t=5 sec;

451 represent the location of the mouse pointer; (i.e. a,c)

452 represent the location of the scroll bar.(i.e. f)

The processing engine (106) may also create and store logs of user's interests, browsing history within webpage, click and cookies etc. These logs can generate real time results of user's interests which can be used for providing more appropriate advertisements to the user.

In step (205), the processing engine (106) triggers an event. The event could be one of the following but not limited to:
Calculate data as per script and send this data to one or multiple servers
Client's database or memory is full, thus send stored data to the web server (102) or third party server (103);
send stored/calculated data to the web server (102) or third party server (103) after a predetermined interval; Say after every “n” seconds.
closing of browser application or webpage.
send stored/calculated data when a slide is changed.

The event triggered in step (205) determines whether the script will send data. Data stored/calculated or logs may be sent to one or multiple predestined web servers (102) or third party servers (103). The sending of stored/calculated data to one or multiple servers may be done using AJAX, AJAJ, JavaScript, XML, node.js or any other similar language.

In step (206), the processing engine (106) transmits calculated data to the web server (102) or third party server (103).

Client device (101) may ask for additional DNS lookup in case of sending data to third party web server(103) to determine IP address of third party server.

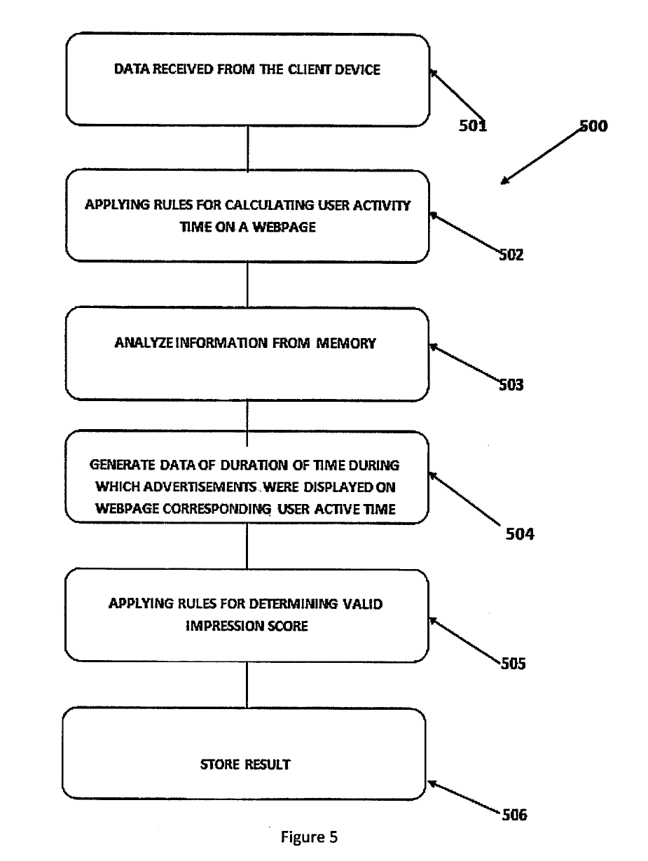

FIG. 5 illustrates the method (500) being implemented on the server device according to an embodiment of the present invention.

In step (501), the web server (102) or third party server (103) receives data from the client device (101) and stores in memory (110). The web server (102) or third party server (103) may serve as a calculation server, if it includes activity methodology, impression methodology ,alteration methodology and billing methodology.

Once data is received from the client device (101), the processing engine (109) implements the activity methodology in step (502). The processing engine (109) applies rules for analyzing user activity data for generating results of user active time on a webpage. User activity data can be determined by combining time based data Of various user initiated events which may include but not limited to touch event, scroll event, keyboard event, rotation event, mouse movement, pinch event, clicks, playing of a video/audio/game/presentation, chat window, initiation of any hardware application (web camera), successful completion of any event or user initiated actions.

The processing engine (109) applies the following rules for calculation of the user active time on a webpage, in case of a touch based device: Rules may include but not limited to:
Time stamp during which touch event is occurred, will be included in active time;
Time stamp during which rotation event is occurred will be included in active time;
Time duration in which a text input form is selected and successfully completed;
Excluding time stamp if a Zoom/Pinch event exceeds a predetermined value, resulting in zooming out of banner advertisement.
If a video file running on client's device we may exclude time during which video is played on full screen mode.
Use of power button.

A combination of the above rules along with few additional rules would reflect time of user activity on a particular webpage.

In this example mouse movement can be detected in many ways which may include but not limited to:
Determining mouse cursor coordinates and comparing them with previous mouse cursor coordinates. If the coordinates change, it reflects user activity;
When mouse movement is detected read/store timestamp;
Generating a grid on backend of webpage using javascript, jscript or any other similar language. This grid can divide the webpage in small rectangular elements, further these small elements can collect data of mouse over event(i.e if mouse/touch event happens on small elements read timestamp). Further collecting mouse over event timestamp in grid element or change in position of mouse pointer in any grid element.
Performing one or multiple mathematical operation between x and y coordinates and then comparing the result with previous result. If the result changes, it reflects user activity. For example taking mathematical operator(+,addition) thus result of (X coordinate+Y coordinate) will be send to one or multiple web servers. While of calculation of active time of user this resulted value will get compared to resulted value of previous time(say 1 sec), if the resulted value changes user was active at that time.

In this example scroll movement can be detected in many ways which may include but not limited to
When scroll movement is detected read/store timestamp;
Up/down/Page up/ down keys of keyboard result in change of positioning of scroll bar;
Comparing position of scroll bar to previous known position. If position changes, it reflects user activity.
Performing one or multiple mathematical operation between horizontal and vertical scroll bar locations, and then comparing the result with previous result. If the result changes ,it reflects user activity. For example taking mathematical operator(+,addition) thus result of (Scroll X+Scroll Y) will be send to one or multiple web servers. While of calculation of active time of user this resulted value will get compared to resulted value of previous time(say 1 sec), if the resulted value changes user was active at that time.

For example of FIG. 4, the processing engine (109) may determine the following conditions: Rules in this example generate results of user activity time on the webpage. Only mouse and scroll movements are considered in this example:

The user was assumed to be active at t=1 sec.(since user entered URL at t=0 seconds).

By comparing 421 with 411, it can be noticed that mouse pointer location has changed at t=2 sec,

Thus, the user was active at t=2sec.

By comparing 431 to 421, it can be noticed that mouse pointer location has changed at t=3, Thus, the user was active at t=3 sec.

By comparing 441 to 431, it can be noticed that the mouse pointer location has not changed at t=4 sec. In this case, checking if any other rule is applicable, which may include but not limited to clicks, scrollbar location/movement, keyboard event, playing a video/audio/game/presentation, usage of camera application, selection or successful completion of any field (chat window etc.) or other similar user initiated events. Say .In this case scroll location rules are applicable, thus comparing 442 and 432, it can be noticed that the scroll bar location has not changed at t=4 sec. Since no other rules are applicable thus, it can be concluded that user was not active at t=4 sec.

By comparing 451 to 441, it can be noticed that the mouse pointer location has not changed at t=5 sec. Further comparing 452 to 442, it can be noticed that, the scroll bar position has changed at t=5sec. Thus, the user was active at t=5sec.

In step (503), the processing engine (109) may analyze information stored in the memory (110) of the web server (102) or the third party server (103). The information stored in the memory (110) may relate to but not limited to the following conditions:
Total number of banner ads being displayed on a webpage;
Total number of advertisements/slides included in a banner ad;
Time duration of display of particular advertisement/slide in specific iteration;
Position of slide in advertisements/slides in a particular banner ad;
Any update initiated by alteration methodology;

In step (504), the processing engine (109) implements the impression methodology where data of user active time generated by the activity methodology is read and analyzed. Further, the processing engine (109) reads information of time associated with display of any particular advertisement/slide and maps the read information with the user active time generated by the activity methodology. Any advertisement/slide included in a slideshow or banner ad may be displayed none, one or multiple number of times during a user's visit on webpage.

In an aspect, comparing user activity time with display time of any particular advertisement may provide results of valid impression of advertisements/slides. Comparing active/inactive time of user, against rendering time of particular slides, will provide data of effective viewership of each slides.

In another aspect, calculation is performed and results are generated considering iteration. Since the advertisements/slides may have infinite loop in slideshow. Further wide range of conditions and parameters are determined by using predefined rules. The impression methodology generates a valid impression score (VIS) of each advertisement/slide displayed in a banner with respect to user active time. However results can also be generated by negating results of user inactive time.

Let us consider an example where a banner ad consists of 5 different advertisements/slides (A, B, C, D and E) and each advertisement/slide is displayed for a period of 10 sec i.e. after every 10 sec the advertisement/slide would automatically change from A-B, B-C, C-D, D-E and E-A and so on. Further, let us consider above example for three iterations i.e. for a time period of 150 sec. Particular rendering of time in seconds for each particular slide(A-E) iteration wise:

| Slide | 1st iteration (time) | 2nd iteration (time) | 3rd iteration (time) |
|---|---|---|---|
| A | 0 to 9 | 50 to 59 | 100 to 109 |
| B | 10 to 19 | 60 to 69 | 110 to 119 |
| C | 20 to 29 | 70 to 79 | 120 to 129 |
| D | 30 to 39 | 80 to 89 | 130 to 139 |
| E | 40 to 49 | 90 to 99 | 140 to 149 |

In this example assume step 502 receives data at a frequency of 10 seconds(similar to frequency of slide changing) and results generated of active time will be determined by same as rules for touch devices, mouse movement and scroll movement.

Active Time (in sec)

| | | | | |
|---|---|---|---|---|
| 1 | 51 | 91 | 111 | 131 |
| 11 | 61 | 101 | 121 | 141 |

The processing engine (109) creates the valid impression score (VIS) as follows:

TABLE 1

| Advertisement/ | (VIS) for | | (VIS) for IIIrd |
|---|---|---|---|
| Slides | Ist Iteration | (VIS) for IInd Iteration | iteration |
| A | 1 | 1 | 1 |
| B | 1 | 1 | 1 |
| C | 0 | 0 | 1 |
| D | 0 | 0 | 1 |
| E | 0 | 1 | 1 |

In this example assume step 502 provide results as below: where data is received on step 501 at a frequency of 1 second, let us consider active user time after implementing activity methodology:

ACTIVE TIME (in seconds)

| | | | | | | | | | | | | | | | |
|---|---|---|---|---|---|---|---|---|---|---|---|---|---|---|---|
| 0 | 5 | 15 | 26 | 54 | 58 | 65 | 69 | 95 | 104 | 114 | 124 | 131 | 135 | 139 | 146 |
| 1 | 11 | 16 | 34 | 55 | 62 | 66 | 85 | 96 | 108 | 116 | 125 | 132 | 136 | 142 | 148 |
| 3 | 12 | 17 | 52 | 56 | 63 | 67 | 86 | 97 | 112 | 122 | 127 | 133 | 137 | 144 | |
| 4 | 13 | 25 | 53 | 57 | 64 | 68 | 92 | 103 | 113 | 123 | 128 | 134 | 138 | 145 | |

The processing engine (109) creates the valid impression score (WS) as follows:

TABLE 2

| | | IInd Iteration | IIIrd |
|---|---|---|---|
| Slides | Ist Iteration (0-49 sec) | (50-99 sec) | iteration (100-149 sec) |
| A | X1 = 5 sec | Y1 = 7 sec | Z1 = 3 sec |
| B | X2 = 6 sec | Y2 = 8 sec | Z2 = 4 sec |
| C | X3 = 2 sec | Y3 = 0 sec | Z3 = 6 sec |
| D | X4 = 1 sec | Y4 = 2 sec | Z4 = 9 sec |
| E | X5 = 0 sec | Y5 = 4 sec | Z5 = 5 sec |

X1-X5, Y1-Y5 and Z1-Z5 sec indicates the time period during which the user was active on the webpage where the banner ad including advertisements A-E is being displayed in different iterations. The values for X1-X5, Y1-Y5 and Z1-Z5 are determined based on the user initiated events (as defined in detail above) and are mapped against the time period of display of the advertisements/slides by the processing engine (109).

In step (505), the processing engine (109) applies various rules for determining the valid impression score (VIS) of each advertisement/slide displayed in the banner advertisement.

The rules may include but not limited to : Comparing values of X1-X5, Y 1-Y5 and Z1-Z5 with a predefined threshold value. If the values of X1-X5, Y1-Y5 and Z1-Z5 exceeds the predefined threshold value, assigning a HIGH otherwise assigning a LOW.

For the example considered above, let us assume the threshold value to be 2.5 sec:

The processing engine (109) creates the valid impression score (VIS) as follows: Table 3:

| | | (VIS) | (VIS) |
|---|---|---|---|
| Slides | (VIS) for Ist Iteration | for IInd Iteration | for IIIrd iteration |
| A | 1 | 1 | 1 |
| B | 1 | 1 | 1 |
| C | 0 | 0 | 1 |
| D | 0 | 0 | 1 |
| E | 0 | 1 | 1 |

Based on the table(1-3), the processing engine (109) outputs the following information:

Slide A is viewed once in the first iteration, once in second iteration and once in third iteration;

Slide B is viewed once in the first iteration, once in second iteration and once in third iteration;

Slide C is not viewed in the first and second iterations, and is viewed once in third iteration;

Slide D is not viewed in the first and second iterations, and is viewed once in third iteration;

Slide E is not viewed in the first iteration, and is viewed once in the second and third iterations.
Rule 2:Adding the VIS defined in table 3 or table 1 for all the iterations for each of slide A-E
Rule 3: Every banner ad is provided with bullets and previous/next buttons. Clicking on the bullets and previous/next buttons may also result in the alteration of the VIS. More specifically, if a user clicks a bullet of advertisement/slide C, the value of generalized VIS score of advertisement/slide C would be increased
Rule 4: If a banner ad is provided with bullets and previous/next buttons. For example if a user clicks on previous button when advertisement/slide D is displayed, thus rendering advertisement/slide C. Further, if a user clicks previous button when advertisement/slide C is displayed, thus rendering advertisement/slide B. This would increase the value of generalized VIS score of advertisement/slide C and advertisement/slide B.

In step (506), the calculated VIS or generalized VIS is stored in the memory (110).

When all the required rules have been applied to calculate VIS, we will have final VIS for advertisements respectively. This generated value of VIS for particular advertisements provides data of actual viewership of advertisements respectively. Generating a transparent system in which advertisers can get detailed data related to user's viewership. One or multiple combinations of RULE 1 to RULE 4 or Table 1 to Table 3 can be implemented to determine VIS(valid impression score).

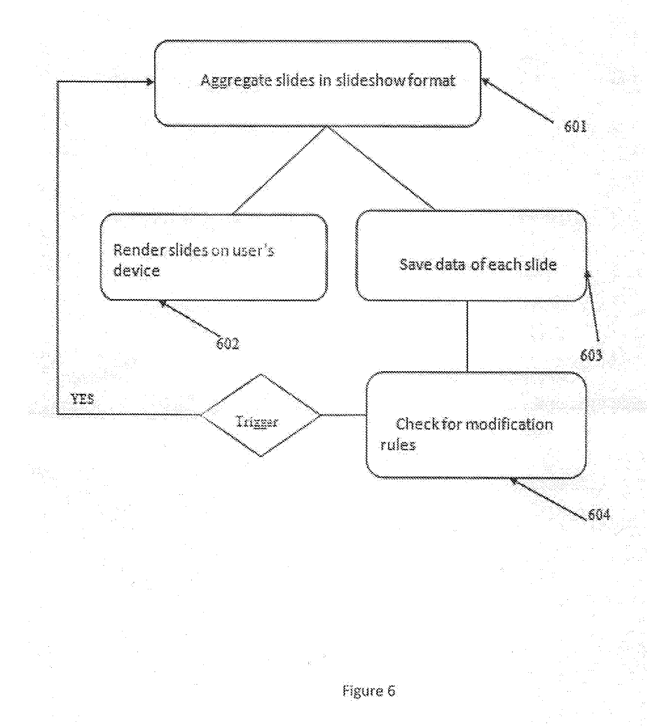

FIG. 6 illustrates the method used to for alteration methodology:

In step 601, calculation web server will aggregate slides to be rendered on webpage from multiple entities. Also determining the position, rendering time etc. for each slide.

In step 602, aggregated slides are rendered on client's device (101) by calculation web server.

In step 603, calculation web server will save data associated which each slide, which may include but not limit to URL, image, text, multimedia, position, rendering time etc. This data will be further stored in memory, which will be further read in step 503.

In step 604, the processing engine (109) may also execute the alteration methodology which may be used for real time rendering/altering one or multiple advertisements/slides included in a banner advertisement. The processing engine (109) may apply rules for analyzing if there is a need for alteration methodology to take action, which may result in removal/insertion/repositioning of one or multiple advertisements/slides in a banner. Few conditions may include but not limited to:
Value of VIS of a particular advertisement/slide exceeding a predefined threshold may lead to removal of that advertisement/slide from the banner ad;
Value of VIS of a particular slide exceeding a predefined threshold may lead to repositioning of that slide with the slide having the least VIS;
Slide with least VIS will replace the position of slide with maximum VIS;
Slide can be rearranged after one iteration, slides with low value of VIS can replace slide with higher values of VIS. Thus rearranging order of slides in iteration;
Event initiated by calculation web server based on previous value of VIS stored in memory;

If any of the following rules are applicable, a trigger event may sent the request for updating to step 601 and rendering updated slideshow on user's device in step 602.

However the best method of performing present invention comprises: initiating trigger event by script at a frequency same as frequency of changing of slides; implementing activity methodology; implementing Impression methodology for generating VIS as in Table 1; and alteration methodology.

Calculation web server uses result of valid impression score after implementing of activity, impression and alteration methodology to initiate billing methodology.

Industrial application of present invention will generate billing methodology; Billing methodology will generate results which can be used by online advertising industry, as an application for effective transactions for advertisers based on accurate viewership of slides.

Calculation web server aggregates slides for various entities, where each entity will correspond to at least one slide. Further each entity will provide data related to particular slide which may include at least one of position, time, URL, image, text, video etc. to calculation web server.

Calculation web server will provide rules for billing and billing criteria to each entity on the basis of valid impression score of each slide.

Rules for billing provided to entity may include but not limited to:
Fixed amount to be paid when a slide is aggregated to be rendered on user's device;
Fraction of amount will be paid based on VIS result generated for corresponding slides;
Amount to be paid on basis of particular VIS value for corresponding slide;

Calculation web server can perform transaction while aggregating slides and rendering slides on clients device, then on basis of any rules and valid impression score few actions can be performed by billing methodology. Rules may include but not limited to:
Refunding of a fractional amount, if value of VIS value for corresponding slide is lower than the value provided in rules by calculation web server to particular entity;
Calculating/Saving the difference in value of VIS of particular slide generated and VIS rule provided by web server. This difference will be further completed by calculation web server till value of VIS rule provided by web server to concerned entity is reached;
Maintaining a fixed and variable account where fixed account will be charged at every rendering, and variable account will be charged on the basis of Valid Impression Score;

On the basis of VIS and rules for each slide, billing methodology will perform billing/transaction of each entity. Thus each entity concerned with each slide will be charged/billed by calculation web server on the basis of valid impression score generated by calculation web server.

The present invention is described with reference to the figures and specific embodiments; this description is not meant to be construed in a limiting sense. Various alternate embodiments of the invention will become apparent to persons skilled in the art upon reference to the description. It is therefore contemplated that such alternative embodiments form part of the present invention.

1. A method for performing web based banner advertising wherein method comprises: providing a webpage by a web server via a network, where multiple user devices requests for webpage for rendering on user's display device, webpage comprises data for advertising along with data provided by web server;
rendering banner on user's device by web server for advertising, A banner includes a static banner or a slideshow banner, a slideshow banner containing multiple number of slides changing at a predetermined interval of time, Once time defined for a particular slide completes next slide renders on webpage;
collecting data of user activity in form of user responses, a script initiates calculating data of user response when a webpage requested by user renders, performing mathematical calculation on response data, and sending data associated with user responses to calculation web server by triggering an event;
receiving data of user responses and calculating active time of user on webpage, performing analysis on data of user response which includes mouse movement, scroll movement, touch, click, zoom, keyboard event and time associated with these responses, generating a active timeline of user;
analyzing data of user response with rendering time of each slide, to generate results of active interaction of user with each slide respectively, calculating valid impression score for each slide based on active time of user and time of display of particular slide;
modifying slides in slideshow and updating changes by rendering updated slideshow banner on user's device, determining rules to add, remove or reposition slides based on results of valid impression score of each slide and rules implemented by calculation web server.

2. A method of claim 1 where collecting user response data by script, which includes at least one of mouse location, scroll location, touch event, click event, zoom, keyboard event, calibration, or time associated with these events; detecting device type to decide which responses to collect, depending on hardware or software of user's device, performing mathematical calculations on user response data such as adding mouse x and y coordinates, triggering an event to send data to predefined web server.

3. A method of claim 1 wherein aggregating multiple slides in one banner space by calculation web server; At any particular instance of time only one out of multiple slides renders on webpage; each slide have a predefined interval of time for rendering after completion of this time next slide renders on webpage and so on; repeating slides once all slides renders, resulting in iterations; saving data associated with position of slide, time of rendering, URL, image, text, multimedia, video, in memory of calculation web server.

4. A method in claim 1 where calculation web server receives data associated with user response, and apply predefined rules for calculating user active time, Calculation web server initiates checking time of user responses to generate a timeline of user initiated responses, determining results of active time of user on webpage.

5. A method of claim 1 wherein comparing result of active time of user with time of rendering of each slide, reading rendering time of each slide from memory; generating result of whether any slide renders during active or inactive time of user; rendering of each slide during active time of user results in valid impression.

6. A method in claim 1 wherein modifying slides in slideshow banner on the basis of valid impression of each slide, altering attributes of slides if a rule is applicable for modifying slides; checking for rules once all the slides included in slideshow have been rendered at least once; altering slides includes repositioning, adding or removing slides; implementing modification in next iteration of slides and updates renders on user's device.

7. A method for performing web based banner advertising wherein method comprises: providing a webpage by a web server via a network, where multiple user devices requests for webpage for rendering on user's display device, webpage comprises data for advertising along with data provided by web server;
rendering banner on user's device by web server for advertising, A banner includes a static banner or a slideshow banner, a slideshow banner containing multiple number of slides changing at a predetermined interval of time, Once time defined for a particular slide completes next slide renders on webpage;
collecting data of user activity in form of response, Script initiates calculating data of user response when a webpage requested by user renders, performing mathematical calculation on activity data, and sending data associated with user responses to calculation web server by triggering an event;
receiving data of user responses and calculating active time of user on webpage, performing analysis on data of user response which includes mouse movement, scroll movement, touch, click, zoom, keyboard event and time associated with these responses, generating a active timeline of user;
analyzing data of user response with rendering time of each slide, to generate results of active interaction of user with each slide respectively, calculating valid impression score for each slide based on active time of user and time of display of particular slide;
modifying slides in slideshow and updating changes by rendering updated slideshow banner on user's device, determining rules to add, remove or reposition slides based on results of valid impression score of each slide and rules implemented by calculation web server;
generating billing records on the basis of analysis of valid impression score of each slide, maintaining a billing record on calculation Web server that receives the slides from multiple entities, calculating billing records for each slide based on the analysis of valid impression score to each concerned entity, and providing billing records for each slide to each concerned entity respectively.

8. A method of claim 7 where calculation web server provide rules, specification and billing criteria to multiple concerned entities; collecting data related to particular slide which may include at least one of position, time, associated URL, image, text, video, into calculation web server memory; aggregating multiple slides in a slideshow by calculation web server to be rendered on user's device, initiating billing records by calculation web server on the basis of result of valid impression of each slide for each concerned entity.

9. A method in claim 7 where billing methodology generates results based on valid impression score for each entity, calculating billing records which reflects billing based on active time of user during rendering of each slide, calculation web server performs transaction on the basis of billing records for each concerned entity.

10. A system for performing web based banner advertising wherein system comprises:
means for providing webpage by a web server via a network, where multiple user devices request for webpage by entering URL in entry field of web browsers, one or multiple web servers provide webpage to be rendered on user's display device, where webpage comprises data for advertising along with data provided by web server;
means for serving slideshow banners to user devices, a banner as a form of advertising renders on webpage, banner includes static as well as slideshow banner, slideshow banner contains multiple number of slides where each slide renders on user device by calculation web server from multiple entities, calculation web server aggregates multiple slides from multiple entities, in a slideshow banner where each entity corresponds to at least one slide, Once time defined for any particular slide is completed next slide renders on webpage;
means for collecting user response data from user's device, A script is executed on user's device when a webpage requested by user renders on user device, Script initiates calculating data of user response, also performing mathematical operations on response data, script sends data associated with user responses to calculation web server when trigger event occurs, a trigger event occurs at a predetermined frequency similar to frequency of rendering of slides or after fixed interval of time;
means for calculating user active time, calculation web server initiates activity methodology where web server receives response data from user device, and analyzes data associated with user response for each user device to generate results of active timeline of user;
means for calculating valid impression of each slide rendered during active time of user, calculation web server implements impression methodology where result of active time of user calculated by activity methodology is compared with time of rendering of each slide stored in memory of calculation web server, Generating results of valid impression of each slide during active time of user;
means for modifying slides in slideshow banner, calculation web server implements alteration methodology for modifying slides in slideshow banner, modification of slides includes to add, remove or reposition slides within slideshow based on results of valid impression score of each slide and rules implemented by calculation web server, also updating slideshow by rendering of modifications of slides on user's device;
means for generating billing records based on the results generated after implementation of activity, impression, alteration methodology and value of valid impression score of each slide, a billing methodology executes on calculation Web server, calculation web server receives slides from multiple entities, maintaining billing records for each slide based on the analysis of valid impression score to each concerned entity, and provides billing records for every slide to each entity respectively.

11. A system of claim 10 where calculation web server provide rules ,specification and billing criteria to multiple concerned entities; each entity provides data related to particular slide which may include at least one of position, time, associated URL, image, text, video to calculation web server; calculation web server aggregates multiple slides in a slideshow to be rendered on user's device, calculation web server implements activity, impression and alteration methodology and initiates billing methodology on the basis of result of valid impression score of each slide for each concerned entity; and calculation web server performs transaction on the basis of billing methodology.

12. A system for performing web based banner advertising wherein system comprises:
A web server for providing webpage via a network, where multiple user devices request for webpage by entering URL in entry field of web browsers, one or multiple web servers provide webpage to be rendered on user's display device, where webpage comprises data for advertising along with data provided by web server;
means for serving banners to user devices as a form of advertising on webpage, banner includes static as well as slideshow banner, slideshow banner contains multiple number of slides where each slide renders on user device by calculation web server from multiple entities, calculation web server aggregates multiple slides from multiple entities, where each entity corresponds to at least one slide in a slideshow banner, Once time defined for any particular slide is completed next slide renders on webpage, calculation web server determines time associated with rendering of each slide;
means for collecting user response data from user's device, A script is executed on user's device when a webpage is requested by user renders on user's device, Script initiates calculating data of user response, also performing mathematical operations on response data, script sends data associated with user responses to calculation web server when trigger event occurs, a trigger event occurs at a predetermined frequency similar to frequency of rendering of slides or after fixed interval of time;
means for calculating user active time, calculation web server initiates activity methodology where web server receives response data from user device, and analyzes data associated with user response for each user device to generate results of active timeline of user;
means for calculating valid impression of each slide rendered during active time of user, calculation web server implements impression methodology where result of active time of user calculated by activity methodology is compared with time of rendering of each slide stored in memory of calculation web server, Generating results of valid impression of each slide during user active time.
means for modifying slides in slideshow banner, calculation web server implements alteration methodology for modifying slides in slideshow banner, modification of slides includes to add, remove or reposition slides within slideshow based on results of valid impression score of each slide and rules implemented by calculation web server, also updating slideshow by rendering of modifications of slides on user's device;

13. A system of claim 12 where script collects user response data associated with at least one of mouse location, scroll location, touch event, click event, zoom event, keyboard event, change in calibration, or time associated with these events; Script includes rules to perform mathematical calculations on user response data; a trigger event sends this data to a predefined web server; script initiates trigger event to send data of user response to calculation web server at a frequency of changing of slides or a predetermined frequency.

14. A system of claim 12 where multiple slides aggregates in one banner space as slides by calculation web server; Data associated with slides is saved in memory of calculation web server which includes position of slide, time of rendering, URL, image, text, multimedia, video; calculation web server initiates activity methodology for calculating user active time based on user's response data received from user's device; maintaining a timeline during which user is active on webpage.

15. A system of claim 12 where result of active time of user calculated by activity methodology is compared with time of rendering of each slide stored in memory of calculation web server, Generating results of impression methodology by comparing user active time with time of rendering of each slide, calculating results of impression methodology for each slide respectively; generating result of valid impression score of each slide, when a slide renders during active time of user.

16. A system of claim 12 where alteration methodology check for rules and modify slides based on valid impression score; alteration methodology includes repositioning, adding or removing slide; Further rules implemented includes repositioning a slide with low value of valid impression score with a slide having higher value of valid impression score, another rule includes removing a slide if value of valid impression score exceeds a predetermined value ,yet another rule includes adding a slide if a slide has been removed by calculation web server; If any rules are applicable for modifying it implements in next iteration of slides and calculation web server updates rendering on user's device.

17. A system in claim 12 where calculation web server aggregates multiple slides from multiple entities in a slideshow banner, where each entity corresponds to at least one slide, calculation web servers provides rules to various entities, also determines time interval of rendering of each slide; once time defined for one slide completes, next slide renders on slideshow banner; once time defined for all slides in slideshow completes, slideshow banner repeats slides or check for rules of alteration, calculation web server implements alteration methodology for modifying slides in slideshow, modification of slides includes to add, remove, reposition slides in slideshow based on result of valid impression score of each slide and rules implemented by calculation web server, also updating slideshow by rendering of modifications of slides on user's device.

18. (canceled)

19. (canceled)
